(19) United States
(12) Patent Application Publication
(10) Pub. No.: US 2010/0131396 A1
(43) Pub. Date: May 27, 2010

(54) Bill Payment Methods

(76) Inventor: Bobby G. Roach, Corinth, MS (US)

Correspondence Address: BAKER, DONELSON, BEARMAN, CALDWELL & BERKOWITZ, PC, 265 Brookview Centre Way, Suite 200, KNOXVILLE, TN, 37919, US

(21) Appl. No.: 12/652,219

(22) Filed: Jan. 5, 2010

Related U.S. Application Data
(63) Continuation-in-part of application No. 11/869,002, filed on Oct. 9, 2007, now abandoned.
(60) Provisional application No. 60/829,870, filed on Oct. 17, 2006.

(51) Int. Cl. G06Q 20/00; G06Q 10/00; G06Q 30/00; G06Q 50/00

(52) U.S. Cl. 705/34; 705/30

(57) ABSTRACT

A method for paying bills is provided. The method includes receiving a list of creditors from a customer, calculating an average of a customer's periodic bills from the creditors, paying the periodic bills of the creditor on behalf of the customer, and charging the customer average periodic payments. The method may further include charging the customer a fee in addition to the average periodic payments. In one aspect, the customer makes periodic payments to a bill servicing entity. In another aspect, the bill servicing entity receives a monthly check on behalf of the customer, and then pays the customer an allowance after the averaged periodic payments are deducted.

### STATEMENT OF RELATED APPLICATIONS

This application claims the benefit of U.S. patent application Ser. No. 11/869,002, entitled “Bill Payment Methods.” That application was filed on Oct. 9, 2007, and is incorporated herein in its entirety by reference.

The parent application, in turn, claimed priority to a then-pending provisional application having U.S. Ser. No. 60/829,870. That application also was entitled “Bill Payment Methods.” That application was filed on Oct. 17, 2006.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### BACKGROUND OF THE INVENTION

1. Field of the Invention

The invention relates to the payment of bills. More specifically, the invention relates to methods for the consolidation and averaging of bill payments for a customer utilizing a computer.

2. Background of the Invention

Traditionally, the payment of household bills has been based on the receipt of a paper statement or invoice from a creditor. Such household creditors may include, for example, a retail store, a residential apartment complex, a car dealership, a mortgage company, a utility, or other creditors. The paper statement is received by the household and a payment slip is returned in a return envelope along with a personal check for payment. This process is repeated for each billing period, typically each month.

Where the bills represent a fixed amount such as is typical for a car note, a furniture note or a rent check, it is easy to budget for the monthly payment. Even those who have a limited income can budget for a fixed monthly amount. However, when the monthly amount fluctuates such as is often the case for a telephone statement, a water bill, an ad valorem tax assessment, or an electric bill, it may be difficult for a person to budget and fully pay for some monthly bills. This is particularly true for those who are on a fixed income or who have limited means.

Recently, an alternative to the conventional bill payment procedure has been offered in the form of electronic bill payment. However, this alternative is of no benefit to the person on a fixed income or who has limited financial means. In this respect, where the bill fluctuates in some months to an amount in excess of what can be paid, offering an electronic mechanism for payment does nothing to solve the debtor's problem. Moreover, most lower income individuals do not have access to a personal computer, and many do not even have a credit card.

U.S. Pat. No. 5,978,780 entitled “Integrated Bill Consolidation, Payment Aggregation, and Settlement System” proposed a system for the electronic payment of bills on behalf of consumers. The payment is made by a bank or other financial institution on behalf of consumers who happen to be account holders at the bank. The bank makes a large, single payment to the “service establishment” on behalf of all subscribing account holders, thereby automating the bill payment system for both account holders and the service establishment. However, this system does not consolidate an individual's monthly bills, nor does it make an overall average of all of the account holder's bills.

Thus, what is needed is an alternative household bill payment system that allows the individual to make a predictable, monthly payment for a plurality of creditors. A system is also needed that equalizes an individual's income after payment of selected monthly (or other time period) statements. Other objects, advantages, and novel features of the present invention will become apparent from the following detailed description when considered in conjunction with the accompanying drawings.

### SUMMARY OF THE INVENTION

A computer-implemented method for the payment of periodic bills is provided. In one aspect, the method includes receiving a list of two or more creditors from a customer, and then paying the periodic bills of each of the two or more creditors on behalf of the customer. The method also includes calculating an average of the periodic bills by the creditors to the customers over a period of time. The method further includes charging the customer average periodic payments based upon the average of the periodic bills of the two or more creditors. The method may also include the step of charging the customer a fee in addition to the average periodic payments.

The creditors may be any company or entity that provides a service or sells a product, and then issues a periodic statement. Examples include mortgage companies, banks, utility districts, and furniture companies. In one aspect, the at least two of the creditors comprise utility companies.

The step of averaging a customer's periodic bills may be done in various ways. In one aspect, the averaging step comprises totaling the bills from a plurality of creditors over a designated period of months, and then taking a monthly average. In another aspect, the step of averaging a customer's periodic bills comprises totaling the bills from a plurality of creditors over a designated period of months, and then taking an average over a fewer number of months so as to produce a higher average.

In one embodiment, the step of paying the periodic bills is conducted on-line.

The method also includes storing payment information into a computer database. The payment information generally includes the customer's name, selected creditors of the customer, corresponding account numbers for the selected creditors, and the average of the periodic bills for the selected creditors over a selected period of time. The process of storing payment information may involve filling out a spreadsheet or responding to queries operated by accounting software. The computer is programmed with operational accounting software to calculate the average of each of the periodic bills.

In one aspect, the company making the payments to the creditor is a bill servicing entity. The bill servicing entity may be a bank, a financial institution, a lending company, a check-cashing business, or other business that handles financial transactions on behalf of account holders. The method may either involve payment from the customer to the bill servicing entity, or payment from an income source of the customer.

In one embodiment, the step of calculating an average of a customer's periodic bills comprises calculating a monthly average of the combined bills from a plurality of creditors over a designated period of months. In this instance, the average periodic payments are the monthly average, paid monthly. Alternatively, the step of calculating an average of a customer's periodic bills may include calculating a weekly average of the combined bills from a plurality of creditors over a designated period of weeks. The average periodic payments may then be, for example, the weekly average, paid weekly. Alternatively, the average periodic payments may be twice the weekly average, paid bi-weekly. In any instance, the average is calculated using the accounting software and the programmed computer.

### BRIEF DESCRIPTION OF THE DRAWINGS

So that the manner in which the features of the present invention can be better understood, certain drawings, flow charts and/or schematics are appended hereto. It is to be noted, however, that the appended illustrations depict only selected embodiments of the inventions and systems and are therefore not to be considered limiting of scope, for the inventions may admit to other equally effective embodiments and applications.

FIG. 1 is a flow chart showing a first embodiment of the invention, referred to as a Direct Payment Plan.

FIG. 2 is a flow chart showing steps for assimilating a list of creditors as may be provided as part of the Direct Payment Plan.

FIGS. 3A, 3B and 3C demonstrate a technique for averaging a Customer's monthly utility bills, and converting them to a periodic payment as may be provided as part of the Direct Payment Plan.

FIG. 3A shows how a Customer's monthly utility bills are averaged and converted to a weekly total.

FIG. 3B shows how a Customer's monthly utility bills are averaged and converted to a bi-weekly total.

FIG. 3C shows how a Customer's monthly utility bills are averaged and converted to a monthly total.

FIG. 4 is a graph demonstrating utility of the Direct Payment Plan offered herein. A customer's monthly income is charted against the customer's monthly expenses.

FIG. 5 is a graph comparing the Customer's monthly income with the customer's averaged monthly expenses.

FIG. 6 is a flow chart showing an alternate embodiment of the invention, referred to as a Reverse Payment Plan.

### DETAILED DESCRIPTION OF CERTAIN EMBODIMENTS

### Definitions

As used herein, the term “Customer” refers to either an individual or a small business that incurs periodic bills.

“Bill Servicing Entity” means a bank, financial institution, lending company, check-cashing service or any other business that handles financial transactions on behalf of account holders.

The term “Creditor” means any company or entity that provides a service or sells a product, and then issues a periodic statement. Non-limiting examples include mortgage companies, banks, lending companies, utility districts or companies, and furniture companies. The term “Creditor” also includes local taxing authorities who make ad valorem assessments.

### Description of Selected Specific Embodiments

The present invention provides methods for the payment of bills from Creditors. The purpose of the methods is to facilitate the payment of periodic bills for various services and utilities. Such bills include, for example, bills for telephone service, water, electricity, gas, rent, car payment, cable, mortgage, and furniture. In one exemplary embodiment, the Creditors accept monthly, electronic transfers of funds for bill payment.

In various embodiments, there are three parties. These are (1) a Customer, (2) a Creditor, and (3) a Bill Servicing Entity. Typically, a plurality of Creditors is involved for each Customer. The term “Customer” refers to either an individual or a small business that incurs periodic bills. Typically, the Customer is an individual, and the periodic bills are monthly bills received at the Customer's house or place of residence.

The Creditor is any company or entity that provides a service or sells a product, and then issues a periodic statement. Non-limiting examples include mortgage companies, landlords, utility companies, car dealerships, and furniture companies. Utility companies are typically cable companies, electricity companies or co-ops, gas companies, municipal water suppliers, and telephone companies. The Bill Servicing Entity may be a bank, a financial institution, a lending company, a check-cashing business, or any other business that handles financial transactions or makes loans on behalf of account holders.

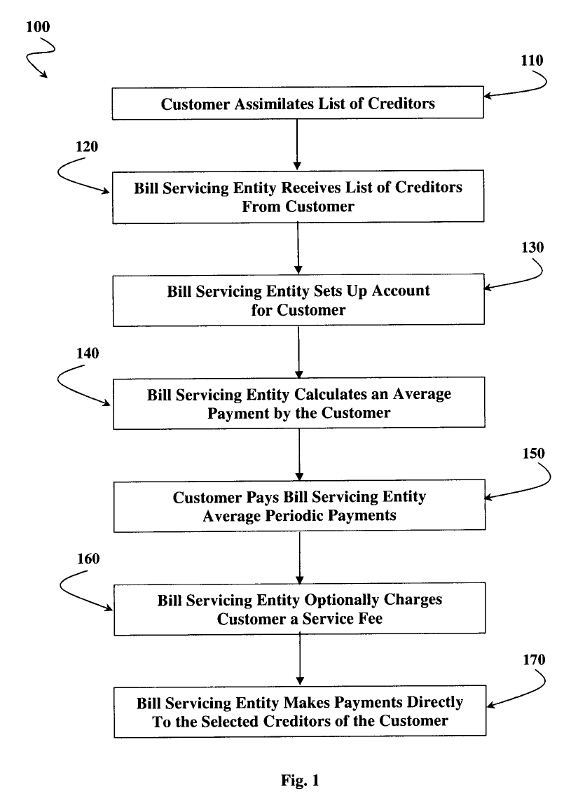

FIG. 1 presents a flow chart showing steps for performing a method 100 of paying bills of the present invention, in one embodiment. The method 100 is for the payment of a Customer's bills. The specific method of FIG. 1 is referred to as a Direct Payment Plan. To initiate the Direct Payment Plan 100, the Customer assimilates a list of his or her Creditors. This step is shown in Box 110 of FIG. 1.

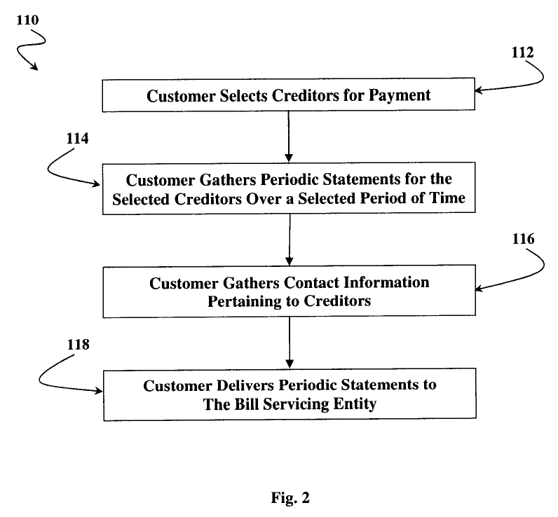

The step 110 of assimilating a list of Creditors itself has various steps. FIG. 2 provides a flow chart that includes possible sub-steps for step 110. First, the Customer selects which creditors will be paid using the bill payment method 100. This step is shown at Box 112. It is noted that the Customer may not wish to include all of his or her Creditors as part of the program 100. For example, the Customer may only desire to have utility payments as part of the program 100. Utility payments may include, for example, cable, telephone, satellite, gas, water, and electricity payments. Therefore, step 112 allows the Customer to make a more narrow determination.

The Customer next may gather periodic statements for the selected Creditors. This step is represented by Box 114. The statements may be paper statements or invoices that have been sent to the Customer by mail. Alternatively, the statements may be printouts of electronic invoices that have been sent to the Customer via e-mail or other transmission. The statements may also include annual tax assessments.

Next, the Customer gathers contact information for the selected Creditors. This step is represented by Box 116 of FIG. 2. The contact information may be included on the statements that have been gathered in the step 114. Alternatively, the contact information may be provided in an original service contract. In this respect, the Customer may optionally assimilate the service contracts as part of the step 116.

Next, the Customer provides the periodic statements to the Bill Servicing Entity. This step is represented by Box 118. This may be done by actually presenting originals or copies of previous statements to the Bill Servicing Entity. Alternatively, the information from the previous statements may be summarized and presented to the Bill Servicing Entity in satisfaction of step 118.

It is noted that in the steps 112 through 118, the steps need not be performed by the Creditor himself. Instead, the steps 112 through 118 may be performed by someone else on the Creditor's behalf. An example is a relative, a caretaker or a social worker. Further, a Bill Servicing Entity may assist the Customer in either gathering statements or viewing them on-line.

Referring again to FIG. 1, the Bill Servicing Entity receives the list of Creditors from the Customer. This receiving step is shown at Box 120. In connection with the receiving step 120, the Bill Servicing Entity may receive the periodic statements gathered by the Customer in step 114. The Bill Servicing Entity may also receive contact information and/or service contracts as gathered by the Customer in step 116.

After receiving the periodic statements in step 120, the Bill Servicing Entity will set up an account (the “Customer's Account”) for the Customer. This is indicated at Box 130 of FIG. 1. The purpose for setting up the Customer's Account is to pay bills to the Customer's Creditors. Preferably, payments are made by the Bill Servicing Entity through electronic payment such as an on-line payment structure using a computer.

As part of setting up the Customer's account in Box 130, payment information is entered and stored into a database. The database resides on a computer, preferably at the place of business of the Bill Servicing Entity. Preferably, the payment information is entered by an employee of the Bill Servicing Entity at the Bill Servicing Entity's place of business. However, the payment information may be entered remotely by a Customer accessing a website of the Bill Servicing Entity.

The computer will have a keyboard for entering data. The computer will also have a graphical user interface such as a screen that has a cursor moved by a mouse or toggle keys. The computer will further have a processor and memory for storing data and instructions. The computer is programmable through software that is downloaded onto a hard drive or otherwise in communication with the processor.

The computer may be a desktop or a laptop computer operating alone at the place of business of the Bill Servicing Entity. Alternatively, the computer may be part of a local area network operating with a main server at the place of business of the Bill Servicing Entity. Alternatively still, the computer may be part of a multi-office network that communicates through an internet connection, and intranet connection, or a so-called cloud computing arrangement.

In any instance, the computer is programmed with operational software for receiving and storing the payment information. The payment information may include, for example, the customer's identification. Such information may include the Customer's name, address, citizenship, aliases, employer, social security number, passwords, and the like. The payment information may also include an identification of the Customer's creditors and corresponding account numbers. In this respect, the Bill Servicing Entity will need to communicate with the creditors in order to coordinate and set up payments.

In order to fund the payments by the Bill Servicing Entity, the method in one embodiment first involves a periodic payment by the Customer to the Bill Servicing Entity. For this reason, the plan 100 is referred to as a Direct Payment Plan. Preferably, the periodic payment by the Customer is monthly. However, the payment may be weekly or bi-weekly or other suitable payment period.

Under the Direct Payment Plan 100, the Bill Servicing Entity pays the Customer's bills to the Customer's Creditors on a monthly basis. However, the Customer does not reimburse the Bill Servicing Entity for the individual payments; rather, the Bill Servicing Entity charges the Customer for an average of the bills.

FIG. 1 shows an averaging step at Box 140. Under this step, the Bill Servicing Entity calculates an average or normalized payment by the Customer. There are various ways for calculating an average. For instance, the Bill Servicing Entity may add the Customer's total bills from all of the selected Creditors over the course of a designated time period such as six months, eight months, a year, or two years, and then divide that amount by the corresponding number of months to reach an average. Alternatively, each Creditor's statements may be averaged over a selected period of time, and the separate averages totaled. In any instance, sufficient data will be collected so that the total amount of a Customer's combined monthly payments can be averaged into one constant payment to the Bill Servicing Entity in increments. The Bill Servicing Entity may then bill the Customer for that averaged amount.

To effectuate the method 100, in one embodiment account balances will be set up for each Customer. The Customer will be responsible for the balance of the account at all times, or if the account is closed. Interest may optionally be added if the account payment is not made on time.

It is noted that the average payment to be made by the customer is calculated by the operational accounting software running on the computer. This becomes part of the payment information for an individual customer. The accounting software allows the computer to be programmed to perform certain of the steps of the methods claimed herein.

In accordance with the Direct Payment Plan 100, the Customer pays the Bill Servicing Entity an average periodic payment. This payment step is shown at Box 150 of FIG. 1. The Customer has various choices for a payment system under step 150. These may include, for example, weekly payments, bi-weekly payments, or monthly payments.

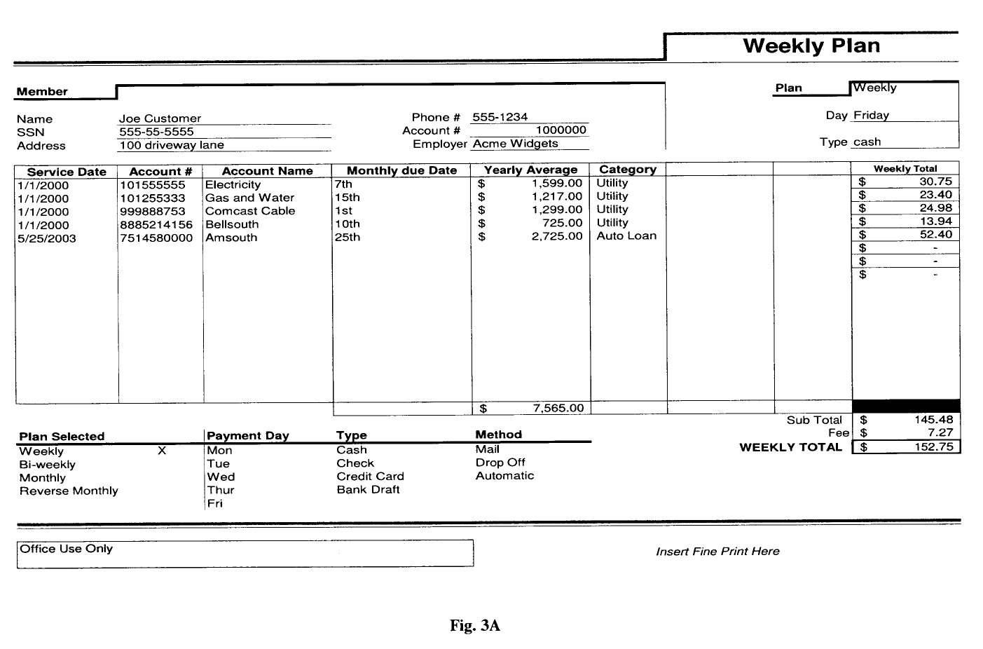

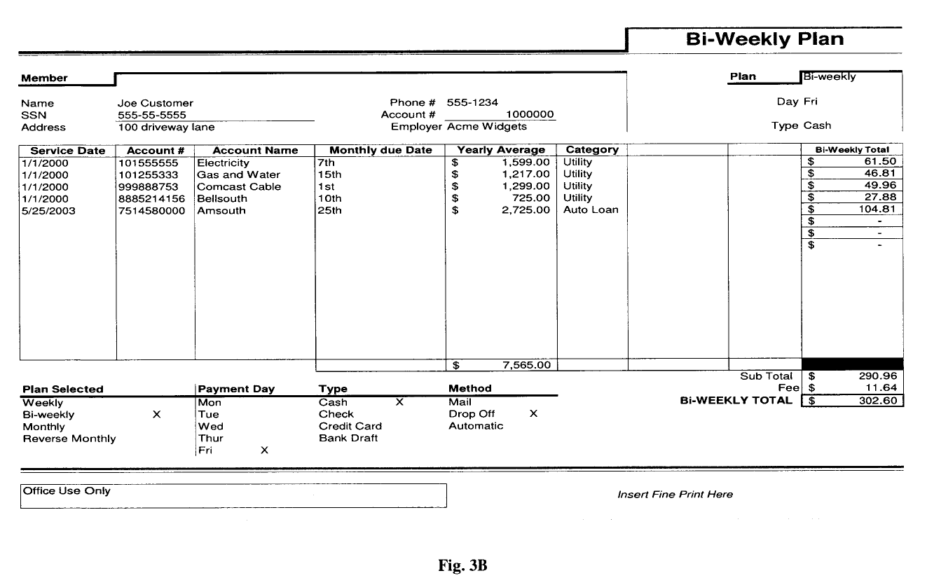

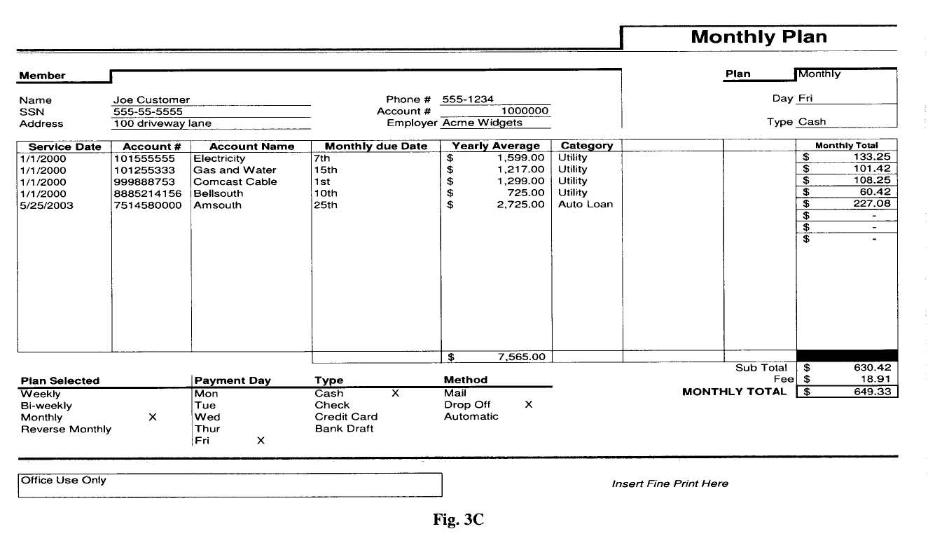

FIGS. 3A, 3B and 3C demonstrate the Customer payment step of Box 150. FIG. 3A shows how a Customer's monthly utility bills may be averaged and converted to a weekly total. This allows the Customer to pay a single weekly amount. In the illustrative chart of FIG. 3A, the weekly payment is $152.75.

FIG. 3B shows how a Customer's monthly utility bills are averaged and converted to a bi-weekly total. This allows the Customer to pay a single amount every other week. In the chart of FIG. 3B, the payment is $302.60. This is roughly twice the weekly payment.

FIG. 3C shows how a Customer's monthly utility bills are averaged and converted to a monthly total. This allows the Customer to pay a single monthly amount. In the chart of FIG. 3C, the payment is $649.33.

Regardless of the payment cycle, payments may be made by the Customer in person, by mail, via automated teller, or at a drop off location. Optionally, the Bill Servicing Entity sends the Customer a reminder concerning each payment 150.

In one aspect of step 150, the Customer selects the payment cycle and the due date. The Customer also chooses the method of payment. Payments may be made, for example, using cash, check, credit card or bank draft. Interestingly, the Customer can make payment of all bills without a checking account.

The account balances will be evaluated and adjusted yearly or as seen necessary. Year-end balances may be averaged into a payment plan for the following year, or settled at that time. In this respect, the actual payments made by the Bill Servicing Entity at the end of the year (or other time cycle) may be slightly higher or slightly lower than the averaged payments actually made by the Customer.

In any of these arrangements, the Customer possibly enjoys certain benefits. For instance, the payments that the Customer makes are now averaged so that the Customer does not suffer fluctuations and surprises in monthly bills. The Bill Servicing Entity makes the payments, preventing the Customer from going into arrears during a high billing month. The Customer's bills are consolidated, meaning that the Customer (who may be poor or elderly or disabled) no longer has to worry about paying multiple monthly bills, but only one bill at one location. Also, the Customer does not have to worry about missing a payment, which in the case of a utility bill could cause them to lose a vital home service and to suffer a shut-off fee, throwing them into a cycle of debt.

It is preferred that the payments made by the Customer in step 150 include a small markup as a Service Fee. Thus, FIG. 1 shows that the Bill Servicing Entity optionally charges the Customer a Service Fee. This is demonstrated in Box 160. In this way, the Bill Servicing Entity is compensated for its services.

The method 100 operates for the payment of bills for a plurality of Creditors. In one aspect, the plan 100 includes up to eight monthly bills. However, additional Creditors may be added. FIG. 1 shows that the Bill Servicing Entity pays the bills of the selected Creditors. This is indicated in Box 170. The payments are made on time to avoid surcharges, foreclosures and service disconnections. In one aspect, the Bill Servicing Entity is responsible for maintaining sufficient funds to cover any applicable bank fees.

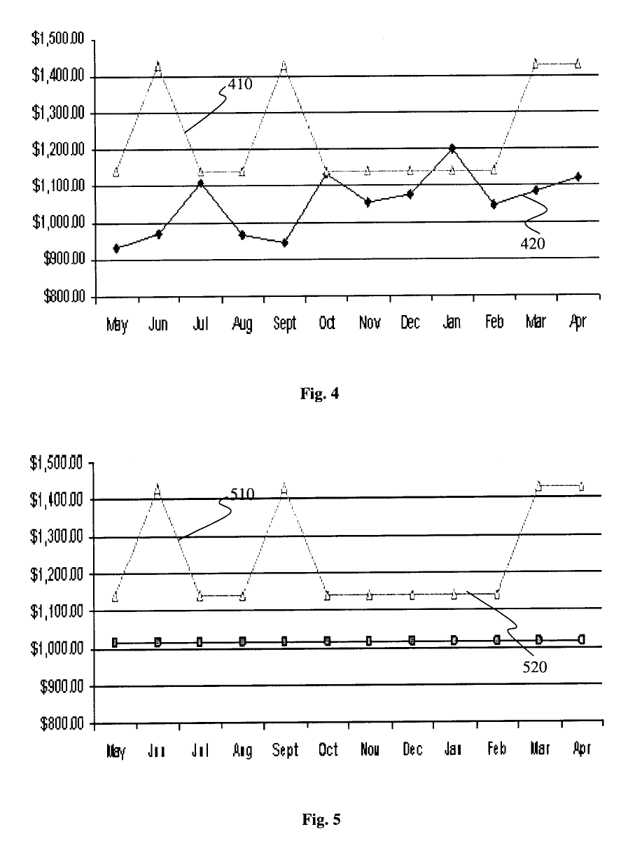

In order to demonstrate the utility of the Direct Payment Plan 100, FIG. 4 is a provided. FIG. 4 is a graph that compares the monthly income of a Customer (depicted along line 410) with the Customer's monthly expenses (depicted along line 420). It can be seen that for this Customer, both the monthly income 410 and the monthly expenses 420 fluctuate.

The fluctuations demonstrated in FIG. 4 are not uncommon for blue collar workers who have jobs that are seasonal or which are weather-dependent. It can be seen that for this Customer, he or she makes more income during the warm weather months than in the cool weather months. It is understood that the winter months come with colder temperatures, shortened daylight hours, holidays and other factors that may affect a blue collar worker's income. At the same time, expenses during the hottest months and the coldest months are increased due to higher utility bills.

Comparing income to expenses more closely, in some months (such as June and September) the Customer experiences a surplus of income 410 relative to expenses 420. However, in other months (namely, October and January) the Customer's income 410 does not exceed his or her expenses 420. Therefore, an averaging of expenses 420 would be beneficial to this Customer.

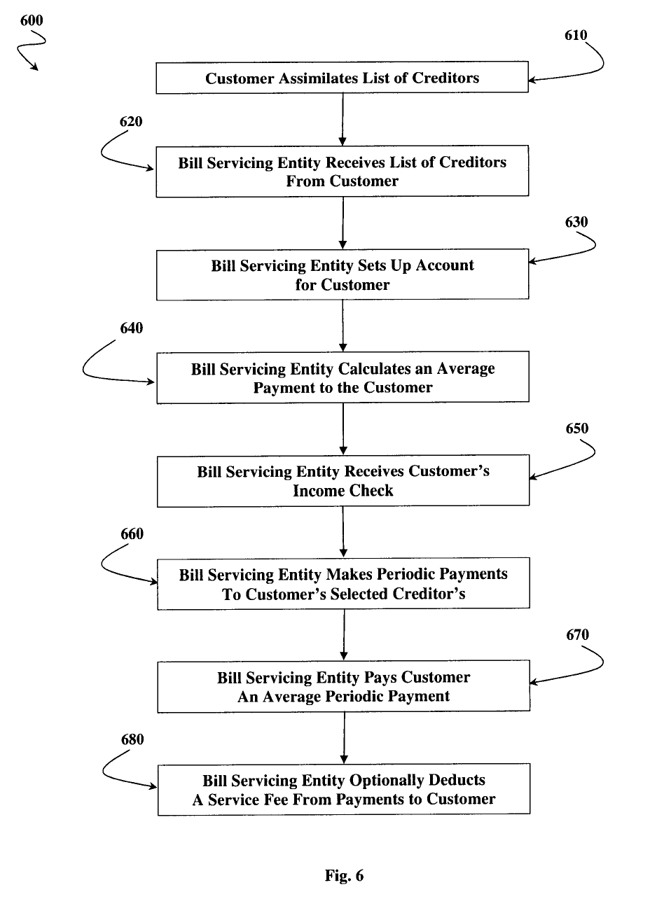

FIG. 5 presents a graph that compares the Customer's monthly income 410 to his averaged monthly expenses 520. It can be seen that the averaged expenses 520 are just over $1,000 per month. The Customer is able to make a consistent, $1,000 per month payment to a Bill Servicing Entity. The Customer also acquires peace of mind knowing that the actual monthly bills are being paid by the Bill Servicing Entity in a timely manner.

There are optional features that may be offered to Customers with the Direct Payment Plan 100. One is a payment insurance feature, meaning that if the Customer has to skip a payment (such as a weekly payment), the Bill Servicing Entity will advance the money on behalf of the Customer, subject to a fee. Another feature is that the average payment made by the Customer may be increased to allow them to skip one or more payments during the year. A skipped payment period may coincide with Christmas or other Holiday, or perhaps a designated vacation week. Also, the Bill Servicing Entity's payments 170 may be adjusted for monthly bills that are added or removed.

In yet another embodiment, the method involves a Reverse Payment Plan 600. Operation of the Reverse Payment Plan is shown in FIG. 6. This plan 600 is typically for Customers who are on a fixed income. In this situation, the Customer receives a monthly check at home. The check may be, for example, a retirement check, a social security check, and/or a disability check. In this plan, the Bill Servicing Entity actually takes possession of the Customer's monthly check(s). Out of the monthly check or checks, the Bill Servicing Entity pays the Customer's monthly bills.

Referring to FIG. 6, the Reverse Payment Plan 600 first includes the Customer assimilating a list of his or her Creditors. This step is shown in Box 610. Step 610 is the same as step 110 of FIG. 1. The discussion of step 110 provided in connection with FIG. 2 and steps 112, 114, 116, and 118 applies with respect to step 610.

The Bill Servicing Entity receives the list of selected creditors from the Customer. This receiving step is shown at Box 620. In connection with the receiving step 620, the Bill Servicing Entity may receive the periodic statements gathered by the Customer in step 114. The Bill Servicing Entity may also receive contact information and/or service contracts as gathered by the Customer in step 116.

After receiving the periodic statements in step 620, the Bill Servicing Entity will set up an account (the “Customer's Account”) for the Customer. This is indicated at Box 630 of FIG. 6. The purpose for setting up the Customer's Account is to pay bills to the Customer's Creditors. Preferably, payments are made by the Bill Servicing Entity through electronic payment such as an on-line payment structure. In accordance with the Reverse Payment Plan 600, setting up the Customer's Account 630 is also for the purpose of paying the Customer an averaged periodic payment. The discussion provided for Box 130 for setting up a Customer's account applies here to Box 630.

FIG. 6 shows an averaging step at Box 640. As with plan 100, the Bill Servicing Entity in plan 600 averages the Customer's monthly bills, and totals the monthly averages for each Creditor. This again is done by using a computer having operational software as described in connection with Boxes 130 and 140 of FIG. 1. However, instead of charging the Customer an average amount billed by the Creditors as in the Direct Payment Plan 100, the Bill Servicing Entity puts the Customer on a periodic “allowance” based on the averaged amount. Thus, under step 640 the Bill Servicing Entity calculates an average payment to be made to the Customer.

Under the Reverse Payment Plan 600, the Bill Servicing Entity receives the income checks of the Customer. This step is shown at Box 650. The checks may be received monthly from the Customer. More preferably, the checks are received directly from the entity issuing the check. Examples of such entities include a 401(k) or other retirement plan administrator, a disability insurance company, a workers' compensation carrier, a previous employer, an underwriting company, or the U.S. Social Security Administration or other government agency providing benefits.

It is noted that the Customer's payment information under the Reverse Payment Plan 600 will involve identification information concerning the entity or entities issuing periodic checks to the Customer. Such information may include the name, address, and other contact information of the check-issuing entity. Such information will also include account numbers and any other data that may aid the Bill Servicing Entity in contacting the check-issuing entity. Of course, the Bill Servicing Entity may also need to provide written consent from the Customer with instructions to the check-issuing entity to have the Customer's checks directed to the Bill Servicing Entity.

Using the funds that represent income to the Customer, the Bill Servicing Entity pays the Customer's bills to the Customer's Creditors. This is indicated in Box 660 of FIG. 6. Payments are made to the Customer's Creditors on a periodic basis. In the Reverse Payment Plan 600, each of the Customer's bills may be set up as drafts or paid electronically from the Customer's account.

Next, the Bill Servicing Entity pays the Customer an average periodic payment. This step is shown in Box 670 of FIG. 6. The periodic payment 670 is the payment calculated in the step of Box 640. The average periodic payment 670 is essentially an allowance. The payment 670 is preferably made monthly; however, the payment 670 may alternatively be bi-monthly, bi-weekly, weekly, or other cycle. The payment 670 to the Customer is a consistent payment, providing the Customer with peace of mind knowing that the bills of the selected Creditors have already been taken care of.

The Customer's “allowance” represents a payment 670 to the Customer after deducting the Customer's average bills. The Bill Servicing Entity distributes the allowance representing the remainder of the funds after deducting the average amount of payments to Creditors to the Customer. Such payments may be by checks to the Customer, or may be deposited into a bank account of the Customer. In one aspect, the payment 670 is paid in the form of a debit card. In any instance, the balance of the Customer's account is maintained through the accounting software.

The Customer possibly enjoys certain benefits from this second method 600. For instance, payments are automatically made on behalf of the Customer so that the Customer need not worry about this himself or herself. The Customer receives a periodic “allowance” from the Bill Servicing Entity. The Bill Servicing Entity makes the full payments, preventing the Customer from going into arrears during a high billing month. The Customer's bills are consolidated, meaning that the Customer (who may be poor or elderly or disabled) no longer has to worry about paying multiple monthly bills. The Customer doesn't have to worry about missing a payment, which in the case of a utility bill could cause them to suffer a shut-off fee and lose a vital home service. The Customer's monthly bills are paid without necessity of a bank account. Finally, the Customer will no longer be required to keep up with due dates for a plurality of bills.

In one aspect, the Bill Servicing Entity may track each Customer's expenses and credits, and provide the Customer with reports as requested.

It is preferred that the Bill Servicing Entity be compensated for its services. Accordingly, the Customer's “allowance” may be made subject to a Servicing Fee. The charging of a Service Fee is shown in Box 680 of FIG. 6.

It can be seen that improved bill payment methods are offered. The methods 100, 600 may allow Customers to budget expenses and payments and break the debt cycle caused by late payment fees, disconnect fees, reconnect fees, returned check fees, overdraft fees and fees for obtaining high interest short-term loans. In addition, Customers can save time and money by eliminating the need to visit multiple bill payment sites.

The foregoing description and examples have been set forth merely to illustrate the inventions and are not intended to be limiting. Since modifications of the disclosed embodiments incorporating the spirit and substance of the inventions may occur to persons skilled in the art, the invention should be construed broadly to include all variations falling within the scope of the appended claims and equivalents thereof. Furthermore, the teachings and disclosures of all references cited herein are expressly incorporated in their entireties by reference.

What is claimed is:

1. A computer-implemented method for the payment of periodic bills of creditors, comprising:
receiving a list of two or more creditors from a customer;
paying the periodic bills of each of the two or more creditors on behalf of the customer;
calculating an average of the periodic bills by the creditors to the customer over a period of time;
charging the customer average periodic payments based upon a sum of the average of the periodic bills from each of the two or more creditors; and
storing payment information into a database residing on a computer, the payment information comprising the customer's identification, the creditors of the customer, corresponding account numbers for each of the creditors, and the average of each of the periodic bills for the creditors over a selected period of time, and wherein the computer is programmed with accounting software to calculate the average of each of the periodic bills.

2. The method of claim 1, further comprising charging the customer a fee in addition to the average periodic payments.

3. The method of claim 2, wherein at least two of the creditors comprise utility companies.

4. The method of claim 1, wherein the periodic bills of the creditors are monthly statements.

5. The method of claim 1, wherein the step of paying the periodic bills is conducted on-line by a bill servicing entity.

6. The method of claim 1, wherein:
the step of calculating an average of a customer's periodic bills comprises calculating a monthly average of the combined bills from a plurality of creditors over a designated period of months; and
the average periodic payments are the monthly average, paid monthly.

7. The method of claim 1, wherein:
the step of calculating an average of a customer's periodic bills comprises calculating a weekly average of the combined bills from a plurality of creditors over the selected period of time; and
the selected period of time is a designated period of weeks.

8. The method of claim 7, wherein the average periodic payments are the weekly average, paid weekly.

9. The method of claim 7, wherein the average periodic payments are approximately twice the weekly average, paid bi-weekly.

10. The method of claim 1, wherein:
the step of calculating an average of a customer's periodic bills comprises totaling the bills from each of the at least two creditors over a designated period of time, and then taking an average over a shorter period of time so as to produce a higher average periodic payment; and
the selected period of time is the shorter period of time.

11. The method of claim 1, wherein:
the step of calculating an average of a customer's periodic bills comprises averaging the bills from each of the two or more creditors over a designated period of months, and then totaling the monthly averages;
the total is the sum of the monthly averages; and
the designated period of months is the selected period of time.

12. The method of claim 1, wherein:
the step of calculating an average of a customer's periodic bills comprises totaling the bills from each of the two or more creditors over a designated period of months, and then taking a monthly average; and
the designated period of months is the selected period of time.

13. The method of claim 2, further comprising:
receiving the average periodic payments from the customer.

14. The method of claim 13, wherein the average periodic payment is a weekly payment, a bi-weekly payment or a monthly payment.

15. The method of claim 14, further comprising:
charging the customer a fee in the event that an average periodic payment is not received by a designated time.

16. The method of claim 1, further comprising:
receiving periodic income checks from or on behalf of the customer;
paying the customer periodic allowances from the income checks; and
the step of charging the customer comprises deducting the average periodic payments from the periodic income checks.

17. The method of claim 16, further comprising charging the customer a fee by deducting the fee from the periodic income checks along with deducting the average periodic payments.

18. The method of claim 17, wherein the step of paying the periodic bills is conducted on-line using a computer by a bill servicing entity.

19. The method of claim 18, wherein the bill servicing entity is a check-cashing service.

20. The method of claim 17, wherein the step of calculating an average of a customer's periodic bills comprises totaling the bills each of the at least two creditors over a designated period of time, and then taking an average over a shorter period of time so as to produce a higher average periodic payment; and
the selected period of time is the shorter period of time.
